(19) United States
(12) Patent Application Publication
(10) Pub. No.: US 2009/0267832 A1
(43) Pub. Date: Oct. 29, 2009

(54) SYSTEMS AND METHODS FOR DYNAMICALLY DETERMINING POSITION

(75) Inventor: James A. Hymel, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/111,412

(22) Filed: Apr. 29, 2008

(51) Int. Cl. G01S 5/14

(52) U.S. Cl. 342/357.09; 342/357.14; 342/357.15

(57) ABSTRACT

A system and method of dynamically determining a position. At least some of the illustrative embodiments are systems comprising a host processor, a sensor configured to send signals indicative of the position of the system to the host processor, an antenna configured to receive signals from GPS satellites, a GPS subsystem coupled to the antenna; wherein the GPS subsystem and host processor are coupled and are configured to make a position determination.

### BACKGROUND

Devices like cellular telephones or personal digital assistants (PDAs) can use a global positioning system (GPS) to determine position, but a GPS-based position determination may, at times, be too inaccurate for a particular application. Continuously determining a more accurate position by a supplementary positioning method that is based on the GPS-based determination may require additional and/or upgraded hardware, may shorten battery life, or both.

### BRIEF DESCRIPTION OF THE DRAWINGS

For a more detailed description of the various embodiments, reference will now be made to the accompanying drawings, wherein:

FIG. 1 illustrates a dynamic, multi-source position determining system in accordance with various embodiments; and

FIG. 2 is a flow diagram illustrating methods in accordance with at least some embodiments.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

“Assert” and “asserted”, in reference to Boolean values, indicates a particular predetermined state, but that predetermined state may take either a high voltage or a low voltage. That is, a Boolean value may be asserted high or asserted low. Likewise, “de-assert” or “de-asserted” indicates a particular predetermined state opposite that of the asserted state.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

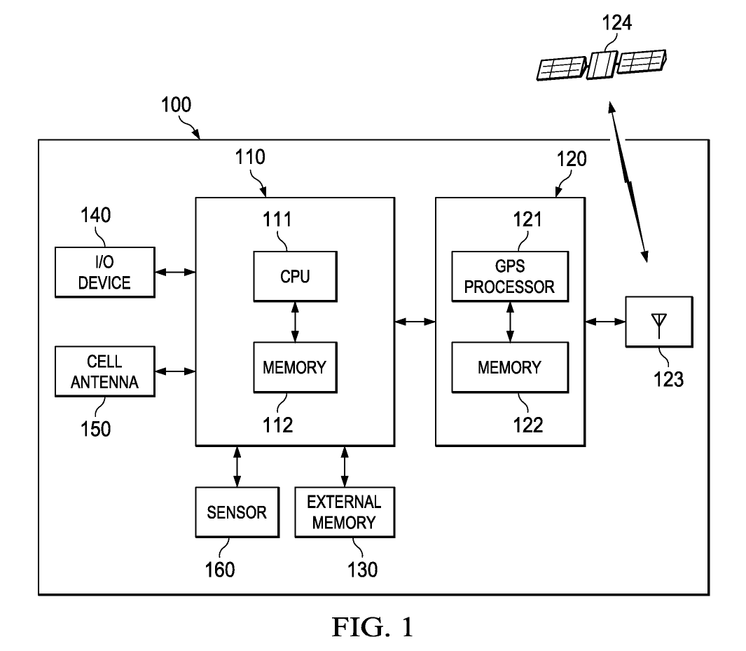

FIG. 1 illustrates a system 100 in accordance with at least some embodiments. In particular, the system 100 comprises a host processor 110 which couples to a global positioning system (GPS) subsystem 120, an external memory 130, an input/output (I/O) device 140, an antenna 150 and sensor 160. In at least some embodiments, system 100 is a mobile device, such as a cellular telephone, or a personal digital assistant (PDA), and thus the host processor 110 may be a processor configured for operation in a cellular telephone or PDA. In some embodiments, the host processor 110 is a microcontroller, and thus the host processor 110 integrally comprises a CPU 111 and on-board memory 112. Either or both the on-board memory 112 or external memory 130 may be used by the host processor for loading and execution of programs, and/or loading and access to data structures used by programs executed by the host processor 110. The I/O device 140 (e.g., a keypad or touch screen) enables a user to interface with the host processor 110, and the antenna 150 enables the host processor to communicate in wireless networks (such as cellular networks). The purpose of the sensor 160 is discussed below.

The GPS subsystem 120 likewise couples to an antenna 123. Unlike the antenna 150 which may be configured for communication in a wireless or cellular network, the antenna 123 is configured to receive signals from GPS satellites 124, and thus the antenna 123 may be equivalently referred to as a GPS antenna. The GPS subsystem 120 further comprises a GPS processor 121 and on-board memory 122. In some embodiments the GPS processor 121 and on-board memory 122 are integrated as an application specific integrated circuit (ASIC). For example, the GPS subsystem 120 may be a part no. NL5500 available from Texas Instruments, Inc., Dallas Tex. The onboard memory 122 stores a program executable by the GPS processor 121, and the program, when executed by the processor 121, in whole or in part enables the GPS subsystem 120 to determine a GPS-based position based on information received from the GPS antenna 123.

The host processor 110 is configured to perform tasks related to the overall functionality of the system 100. For example, in the case where the system 100 is a cellular telephone, the host processor 110 receives an input from the I/O device 140 (e.g., a cellular telephone keypad and/or screen) which causes the host processor 110 to access the memory 112 to find a telephone number. In the illustrative case of system 100 being a cellular telephone, host processor 110 then facilitates the placing of a phone call, and sending the appropriate data to the I/O device 140 to be displayed on the screen.

The GPS subsystem 120 is configured to determine a GPS-based position by way of the signals received from GPS satellites 124. In some embodiments, the GPS-based position is determined by calculating the intersection of spheres formed around at least three GPS satellites 124 (i.e., triangulation). In particular, signals received from GPS satellites 124 comprise the location of the satellites (i.e., the center of a sphere), and by estimating how far away the GPS satellites 124 are from the GPS subsystem 120 (i.e., the radius of a sphere), the GPS subsystem 120 is able to calculate the intersection of the spheres and determine the GPS-based position of the system 100.

In addition to the GPS-based position, the GPS subsystem 120 also determines a value indicative of sufficiency of the signals from GPS satellites 124 to accurately determine position. The sufficiency of the signals is based on various factors. For example, the number of GPS satellite 124 transmissions received affects sufficiency of the signals, with fewer satellites resulting in less sufficiency. Yet another example is the signal-to-noise (SNR) ratio of received GPS satellite 124 transmissions. Further still, clustering of GPS satellite 124 locations affects sufficiency of the signals (e.g., if all received satellite transmissions are from satellites in western sky, the accuracy of GPS-based position may be low). Regardless of the reason for sufficiency or insufficiency of the signals, the GPS subsystem 120 is configured to calculate the GPS-based position to the best of its ability and send the calculated GPS-based position along with the value indicative of sufficiency to the host processor 110. The value indicative of sufficiency may take many forms. In some embodiments the value indicative of sufficiency is a numerical value indicating a distance the GPS-based position could be in error, which numerical value may be referred to as a “dilution of precision” value. For example, if the GPS subsystem 120 calculates a position, and further determines that the position is accurate to within 15 meters, the GPS subsystem 120 sends the GPS-based position and a value representing 15 meters to the host processor 110. In other embodiments, the value indicative of sufficiency is a Boolean value that is asserted when the GPS-based position is within a predetermined accuracy, and de-asserted when the GPS-based position is outside a predetermined accuracy. For example, if the GPS subsystem 120 calculates a position, and further determines that the position accuracy is outside a predetermined range, the GPS subsystem 120 sends the GPS-based position and the de-asserted Boolean value to the host processor 110.

Still referring to FIG. 1, in accordance with at least some embodiments, the system 100 has two configurations and the ability to switch between operating in the first configuration and operating in the second configuration. In the first configuration, the GPS subsystem 120 calculates the GPS-based position and passes the position to the host processor 110. The host processor 110 uses the GPS-based position received from the GPS subsystem 120 as the actual position of the system 100. For example, if the system 100 is outside or otherwise exposed to several GPS satellites 124, and the GPS-based position determined by the GPS subsystem 120 has sufficient accuracy to be used directly by the host processor 110 (e.g., cellular phone-based driving directions, 911 location), then the host processor 110 uses the GPS-based position as the actual position of the system 100. In the first configuration, since the host processor 110 does not need to be powered to perform actual position determination, the power consumption of the system 100 is low.

In the second configuration, the GPS subsystem 120 calculates a GPS-based position and passes the position to the host processor 110. The host processor 110 uses the GPS-based position received from the GPS subsystem 120 as a partial position of the system 100. Further, the host processor 110 acquires supplementary position data, and based on the supplementary position data and the partial position, calculates actual position. For example, the system 100 may be used in an urban location where line-of-sight to orbiting GPS satellites 124 is limited by various structures. The GPS subsystem 120 calculates the GPS-based position, and using the GPS-based position as the partial position, and supplementary position data, the host processor 110 calculates an actual position.

The sensor 160, used by the host processor 110 to obtain supplementary position data, may take many forms. In some embodiments, the sensor 160 is an inertial sensor (e.g., accelerometer, a gyroscope, or other motion-sensing device). In embodiments using an inertial sensor, the host processor 110 knows or is provided an initial actual position, and using the inertial sensor data and the partial position (i.e., GPS-based position of limited accuracy), the host processor 110 keeps track of the actual position of the system 100. In other embodiments, the host processor 110 does not know or is not provided an initial actual position but the host processor 110 uses the partial position and the inertial sensor data to determine actual position.

In other embodiments, the sensor 160 is an antenna configured to receive signals from a wireless communication antenna (and thus sensor 160 and antenna 150 may be one in the same). In embodiments using an antenna as the sensor 160, the host processor knows or is provided an initial actual position, and using data from the antenna and the partial position (i.e., GPS-based position of limited accuracy), the host processor 110 keeps track of the actual position of the system 100. In other embodiments, the host processor 110 does not know or is not provided an initial actual position, but the host processor 110 uses the partial position and data from the antenna to determine actual position. For example, using an antenna as sensor 160, the host processor 110 may receive wireless signals from known points of origin (e.g., wireless Internet access of limited spatial extent provided by a coffee shop of known location, the user's home wireless network). As another example, the host processor 110 may monitor changes in signal strength of wireless signals of known origin to determine whether the system 100 is moving toward or away from the origin of the wireless signal. As yet another example, the antenna as sensor 160 may be directionally sensitive, and thus in combination with the partial position, the host processor 110 may determine actual position based on the direction to a known point of origin of wireless signals.

In yet still other embodiments, the sensor 160 is an antenna configured to receive signals from an Earth-bound positioning system, such as a Very High Frequency Omi-directional Radio Range (VOR) station used by aircraft for navigation. In these illustrative embodiments, once a general location is known (such as provided by the GPS-based position, which may be either a partial position or actual position) the host processor 110 may configure itself to receive signals from particular VOR stations, and determine supplementary position data such as along which radial to the VOR station the system 100 resides, and (depending on the functionality of the station) the distance between the system 100 and the station. Further, the host processor 110 may be configured to simultaneously receive signals from multiple Earth-bound positioning systems, and thus determine actual position as the intersection of radials to the two VOR stations.

Still referring to the second configuration, the host processor utilizes the GPS-based position obtained from the GPS subsystem 120 as a partial position and the supplementary position data received from the sensor 160 to determine the actual position of the system 100. For example, where an application requires a dilution of precision of at most 25 meters, if the GPS subsystem 120 is able to determine a GPS-based position having a dilution of precision of 50 meters (i.e., a partial position) and the sensor 160 is an antenna configured to receive signals from a wireless communication antenna, the host processor 110 acquires supplemental position data from the wireless communication network. The host processor 110 then combines the partial position with the supplemental position data to determine a position of the system 100 having a dilution of precision less than 25 meters. In the second configuration, the host processor 110 is fully powered and active, and thus the system 100 uses more power than the first configuration, where the GPS subsystem provides the GPS-based position being the actual position.

Switching between the first configuration and second configuration, and therefore switching between a first power consumption and a second power consumption, may take various forms. In some embodiments, the GPS subsystem 120 is configured to send the GPS-based position and the value indicative of sufficiency of the signals in the form of a value indicative of dilution of precision to the host processor 110. In these embodiments, the host processor 110 determines whether to operate in the first or second configuration based on the value indicative of dilution of precision. For example, the dilution of precision value may indicate that the GPS-based position is in error by a particular value (e.g., 15 meters, 25 meters). The error could be due to reasons such as: a poor number of GPS satellite 124 transmissions received, unacceptable signal-to-noise (SNR) ratio of received GPS satellite 124 transmissions, or clustering of GPS satellite 124 locations (e.g., all received satellite transmissions are from satellites in western sky). In the case where the error exceeds a predetermined value, the host processor 110 causes the system 100 to operate in the second configuration.

In other embodiments, the GPS subsystem 120 is configured to send the value indicative of sufficiency of the signals in the form of a Boolean that indicates sufficiency of the GPS-based position. In these embodiments, the GPS subsystem 120 is configured to de-assert the Boolean when the position calculated by the GPS subsystem 120 could be in error by more than a predetermined value (e.g., 15 meters, 25 meters). This error could be due to reasons such as: a poor number of GPS satellite 124 transmissions received, unacceptable signal-to-noise (SNR) ratio of received GPS satellite 124 transmissions, or clustering of GPS satellite 124 locations. In the case where the Boolean is de-asserted, the host processor 110 switches the system 100 to operate in the second configuration as discussed above.

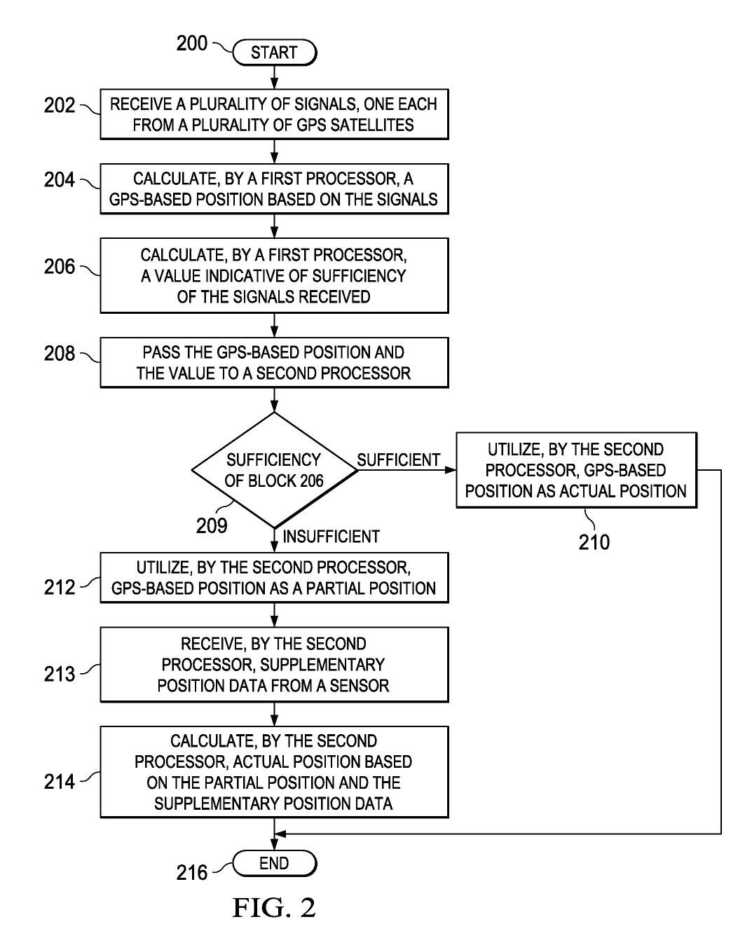

FIG. 2 illustrates a method of dynamically calculating a position. In particular, the method starts (block 200) and proceeds to a first processor receiving a plurality of signals, one each from a plurality of GPS satellites 124 (block 202). Thereafter, the first processor calculates a GPS-based position using the signals received (block 204) and a value indicative of sufficiency of the signals received (block 206). The first processor then passes both the GPS-based position and the value to a second processor (block 208). If the value indicates sufficiency of signals (e.g., a dilution of precision of less than 25 meters) (block 209), the second processor utilizes the GPS-based position as actual position (block 210) and the method ends (216). In the alternative, if the value does not indicate sufficiency of signals (e.g., a dilution of precision of more than 25 meters) (block 209), the second processor utilizes the GPS-based position as a partial position (block 212), receives supplementary position data from a sensor 160 (block 213), and calculates the actual position based on the partial position and the supplementary position data (block 214) and the method ends (block 216).

In some embodiments, when the first processor calculates a value indicative of sufficiency of the signals received (block 206), the first processor calculates based on a number of factors such as: number of GPS satellite 124 transmissions received, signal-to-noise (SNR) ratio of received GPS satellite 124 transmissions, or clustering of GPS satellite 124 locations (e.g., all received satellite transmissions are from satellites in western sky). In some embodiments, when the second processor receives the value indicative of sufficiency, the second processor receives a particular value that indicates position error. In the case where the error exceeds a predetermined value, the second processor determines a lack of sufficiency of the signals received (block 209). In the case where the error does not exceed a predetermined value, the second processor determines sufficiency of the signals received (block 209).

In other embodiments, when the second processor receives the value indicative of sufficiency, the second processor receives a Boolean that indicates sufficiency. In the case where the Boolean is de-asserted, the second processor determines a lack of sufficiency of the signals received (block 209). In the case where the Boolean is asserted, the second processor determines sufficiency of the signals received (block 209).

From the description provided herein, those skilled in the art are readily able to combine software created as described with appropriate general-purpose or special-purpose computer hardware to create a computer system and/or computer subcomponents in accordance with the various embodiments, to create a computer system and/or computer subcomponents for carrying out the methods of the various embodiments, and/or to create a computer-readable media for storing a software program to implement the method aspects of the various embodiments.

The above discussion is meant to be illustrative of the principles and various embodiments of the present invention. Numerous variations and modifications will become apparent to those skilled in the art once the above disclosure is fully appreciated.

What is claimed is

1. A system comprising:
a host processor;
a sensor coupled to the host processor, the sensor configured to send signals indicative of position of the system to the host processor;
an antenna configured to receive signals from Global Positioning System (GPS) satellites; and
a GPS subsystem coupled to the host processor and the antenna, the GPS subsystem configured to calculate a GPS-based position and send the GPS-based position to the host processor;
the system has a first configuration where the host processor is configured to use the GPS-based position as an actual position of the system, and a second configuration where the GPS-based position is a partial position and the host processor is configured to determine actual position using the GPS-based position and the signals indicative of position from the sensor.

2. The system of claim 1 wherein the sensor further comprises at least one selected from the group consisting of: an inertial sensor; an antenna configured to receive signals from a wireless communication antenna; an antenna configured to receive signals from an Earth-bound positioning system.

3. The system of claim 1 further comprising:
the GPS subsystem is configured to calculate a value indicative of sufficiency of the signals from GPS satellites for actual position determination, and pass the value to the host processor; and
the host processor is configured to configure the system to operate in the first configuration when the value indicates sufficiency, and to configure the system to operate in the second configuration when the value indicates insufficiency.

4. The system of claim 3 wherein when the GPS subsystem calculates the value, the GPS subsystem evaluates at least one selected from the group consisting of: the number of GPS satellite transmissions received; the signal-to-noise (SNR) ratio of received GPS satellite transmission; and dilution of GPS satellite precision.

5. The system of claim 3 wherein when the GPS subsystem calculates the value, the GPS subsystem calculates a dilution of precision, and when the dilution of precision is less than 25 meters, the value indicates sufficiency.

6. The system of claim 3 wherein when the GPS subsystem calculates the value, the GPS subsystem calculates a dilution of precision, and when the dilution of precision is equal to or greater than 25 meters, the value indicates insufficiency.

7. The system of claim 3 wherein when the GPS subsystem calculates the value, the GPS subsystem calculates the value to be a Boolean, and when the value is asserted, the value indicates sufficiency.

8. The system of claim 3 wherein when the GPS subsystem calculates the value, the GPS subsystem calculates the value to be a Boolean, and when the value is not asserted, the value indicates insufficiency.

9. A method comprising:
receiving a plurality of signals, one each from a plurality of Global Positioning System (GPS) satellites;
calculating, by a first processor, a GPS-based position based on the signals and a value indicative of dilution of precision of the position calculation;
passing the GPS-based position and the value to a second processor;
utilizing, by the second processor, the GPS-based position as actual position when the value indicates sufficient precision; and
calculating, by the second processor, actual position based on the GPS-based position and supplementary position data when the value indicates insufficient precision.

10. The method of claim 9 wherein calculating the value indicative of dilution of precision by the first processor further comprises analyzing at least one selected from the group consisting of: the number of GPS satellite transmissions received; the signal-to-noise ratio (SNR) of received GPS satellite transmission; proximity of source of GPS signals received.

11. The method of claim 9 wherein calculating the value indicative of dilution of precision by the first processor further comprises calculating a value indicative of distance the GPS-based position could be in error.

12. The method of claim 9 wherein calculating the value indicative of dilution of precision by the first processor further comprises calculating a Boolean value that, when asserted, indicates sufficient precision, and when not asserted indicated insufficient precision.

13. The method of claim 9 wherein calculating actual position by the second processor further comprises calculating using supplementary position data being at least one selected from the group consisting of: signals from an inertial sensor; signals from an antenna configured to receive signals from a wireless communication antenna; signals an antenna configured to receive signals from an Earth-bound positioning system.

14. A computer-readable media storing a program that, when executed by a processor, causes the processor to:
receive a position indication from a Global Positioning System (GPS) subsystem coupled to the processor;
utilize the position indication as an actual position when a dilution of precision of the position indication is below a first predetermined value; and
calculate an actual position based on the position indication and supplemental position data when the dilution of precision is above a second predetermined value.

15. The computer-readable media of claim 14 wherein when the processor receives, the program further causes the processor to receive a value indicative of dilution of precision of the position indication.

16. The computer-readable media of claim 14 wherein when the processor receives, the program further causes the processor to receive a numerical distance value indicative of dilution of precision of the position indication.

17. The computer-readable media of claim 14 wherein when the processor receives, the program further causes the processor to receive a Boolean value indicative of dilution of precision of the position indication.

18. The computer-readable media of claim 14 wherein when the processor calculates actual position, the program further causes the processor to calculate actual using the position indication and information indicative of location received from at least one selected from the group consisting of: an inertial sensor, an antenna configured to receive signals from a wireless communication antenna; an antenna configured to receive signals from an Earth-bound positioning system.

19. A computer-readable media storing a program that, when executed by a processor, causes the processor to:
calculate a position based on a plurality of signals, one each from a plurality of Global Positioning System (GPS) satellites;
determine a value indicative of dilution of precision of the position;
generate a Boolean value that is asserted if the dilution of precisions is less than a first predetermined value, and that is not asserted if the dilution of precision is greater than a second predetermined value; and
send the position and the Boolean value to a host processor.

20. The computer-readable media of claim 19 wherein when the processor determines, the program causes the processor to determine based on at least one selected from the group consisting of: number of GPS satellite signals received; the signal-to-noise ratio (SNR) of received GPS satellite signals; and proximity of the GPS satellites from which signals are received.
